(19) United States
(12) Patent Application Publication
(10) Pub. No.: US 2022/0049528 A1
(43) Pub. Date: Feb. 17, 2022

(54) Door Stopper

(71) Applicant: Justin Rivard, Somerset, WI (US)

(72) Inventor: Justin Rivard, Somerset, WI (US)

(21) Appl. No.: 17/515,500

(22) Filed: Oct. 31, 2021

Related U.S. Application Data
(62) Division of application No. 16/444,100, filed on Jun. 18, 2019.
(60) Provisional application No. 62/691,105, filed on Jun. 28, 2018.

(51) Int. Cl. E05C 19/00

(52) U.S. Cl. CPC E05C 19/003; E05Y 2900/132

(57) ABSTRACT

A door barricade device having a plate secured to an outward opening room door on a room side of the door; the plate having a pair of rails which engage a doorstop device which slides into the rails and abuts the doorframe inside the room, to prevent the door from opening outwardly. The room can be a classroom

### CROSS-REFERENCE TO RELATED APPLICATIONS

This application is a divisional of Ser. No. 16/444,100 filed Jun. 18, 2019 which claims priority to provisional patent application No. 62/691,105, which was filed Jun. 28, 2018, and the entire contents of which is hereby incorporated by reference.

### STATEMENT REGARDING FEDERALLY SPONSORED RESEARCH

Not Applicable

### FIELD OF THE INVENTION

The present invention relates to a door barricade device which can help students and employees remain safe in an active shooter situation.

### DESCRIPTION OF THE PRIOR ART

17 year old student Justin Rivard, invented his door stopper, to help other students and employees to remain safe in active shooter situations. ALICE, Active shooter training in schools, focuses on barricading doors as a critical step to allow first responders to arrive at the scene. When Somerset WI high school conducted their training, it became clear that using tables and other “heavy” items were very easy to move, especially on tile floors and industrial carpet, where things slide easily. When a shop teacher challenged Justin to do better, a 2 year design and refinement journey began which resulted in a door barricade device called JUSTINKASE.

What was needed was a door stopper device, which was easy to deploy when necessary, and inexpensive, so the device could be available in every classroom.

### SUMMARY OF THE INVENTION

The general purpose of the present invention, which will be described subsequently in greater detail, is for a door barricade device having a bar with two structures attached at either end of the bar, which slide under a door and engage the doorframe, to prevent a door from opening into a room, such as a classroom. The bar can be telescoping, having two portions with one slidably received within the other portion, to allow for adjustment to doors of varying widths. The telescoping bar can have a locking device to lock the bar into a predetermined width. The structures attached at either end can be a pair of footers, each with a post attached, with the posts being shaped to conform to the room frame.

An alternative embodiment for a door which opens outwardly from the room is a door barricade device having a plate secured to the outwardly opening room door on a room side of the door, with the plate having a pair of rails which engage a doorstop device which slides into the rails and abuts the doorframe inside the room, to prevent the door from opening outwardly.

These together with other objects of the invention, along with the various features of novelty which characterize the invention, are pointed out with particularity in the claims annexed to and forming a part of this disclosure. For a better understanding of the invention, its operating advantages and the specific objects attained by is uses, reference should be made to the accompanying drawings and descriptive matter in which there are illustrated preferred embodiments of the invention.

### BRIEF DESCRIPTION OF THE DRAWING

The invention will be better understood and objects other than those set forth above will become apparent when consideration is given to the following detailed description thereof. Such description makes reference to the annexed drawing wherein:

FIG. 1 shows a first embodiment of the invention for an inwardly opening door.

FIG. 2 is top view of a second embodiment of the invention before it is slide under the door, showing the posts and feet, which can be shaped to conform to the frame.

FIG. 3 is a top view of the portion of the invention on the inside of a room, with the feet in an intermediate position.

FIG. 4 shows the invention with the posts in the fully deployed position, so the feet are in contact with the frame and lock the device to prevent the door from opening inward into the room.

FIG. 5 is a top view showing the deployed position.

FIG. 6 is a top view showing the outside portion of the invention, with the feet gripping the frame in the fully deployed position.

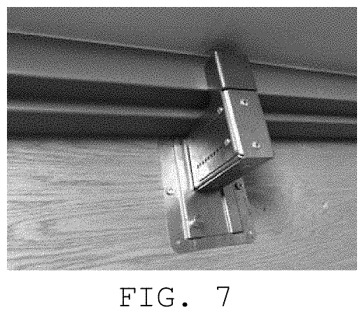

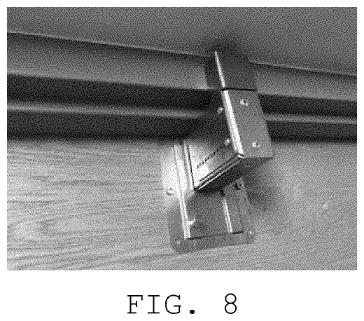

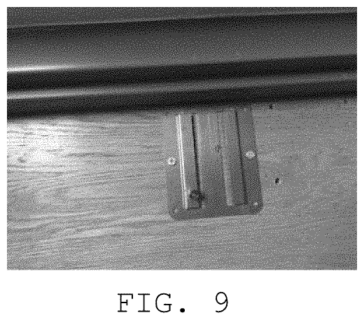

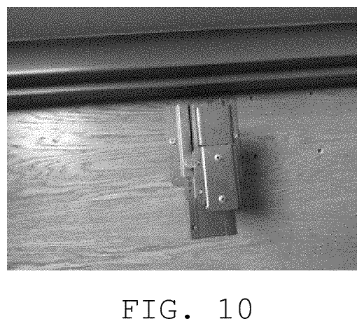

FIG. 5 is a top view of FIG. 4.

FIG. 7 shows a third embodiment of the invention for an outwardly opening door.

FIG. 8 is another view of the second embodiment of the invention.

FIG. 9 is a view of the plate attached to the door, with the two rails.

FIG. 10 is shows the door stopper partially slide onto the rails of the plate.

FIG. 11 shows the second embodiment with the door opened.

### DETAILED DESCRIPTION OF THE INVENTION

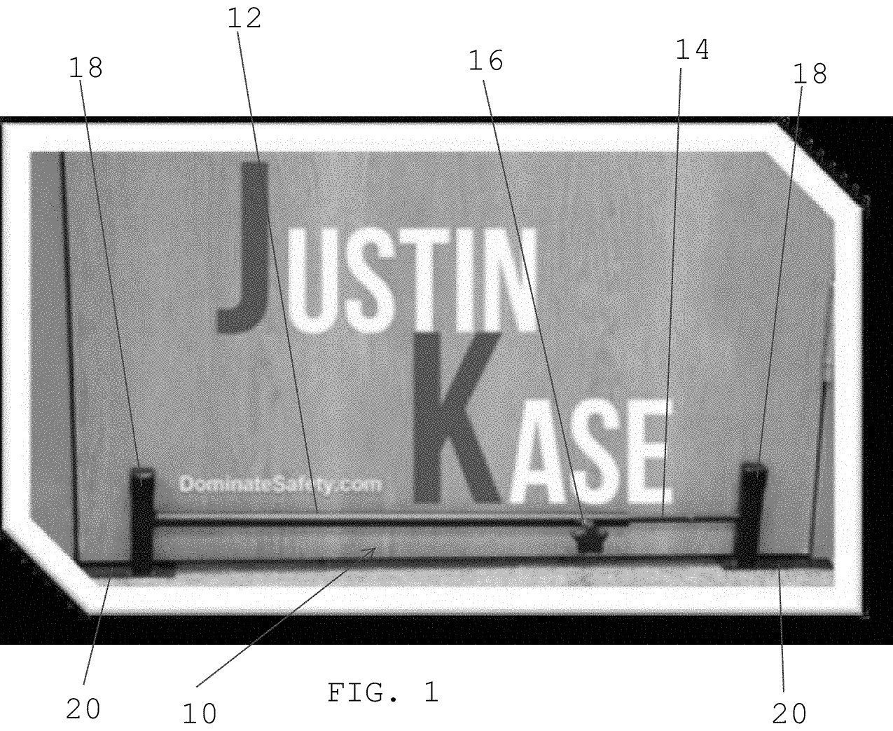

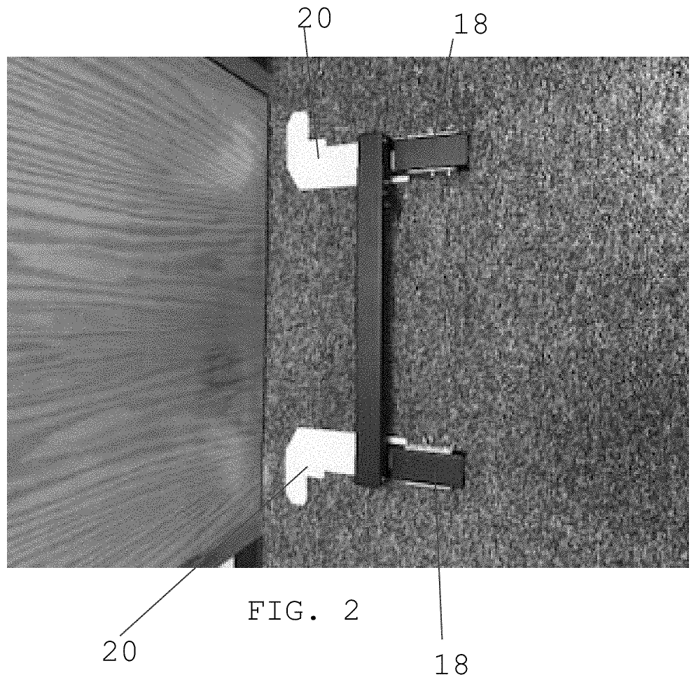

With reference now to the drawing, and in particular to FIGS. 1 through 13 thereof, the door stopper, embodying the principles and concepts of the present invention will be described.

Referring now to FIG. 1, a first embodiment of the door stopper is shown generally at 10. The door stopper has two telescoping bar portions 12 and 14, with the portion 14 sliding into the portion 12, so the bar can adjust to different door widths. A locking portion 16 is used to lock the telescoping bar into the desired position. Attached at each end of the bar are posts 18. Feet 20 are connected to each post 18, the feet conforming to the frame to prevent the door from opening inwardly into the room. This embodiment fits doors 32-44 inches wide and secures doors which open inward into a classroom. To accommodate the different door frame sizes, there are six different sizes of posts.

To use the door stopper you:
1. Place the device footers flat on the floor, footers facing the door, with the locking knob facing towards you.
2. Push the device footers under the door so that the posts on the end of each side of the device remain in direct contact with the door.
3. Slightly unscrew, turn to left, the knob so that the connecting pole is unsecured which will allow you to stretch the device left and right to become secured into the door frame.
4. Turn the locking knob to the right until the device is locked.
5. Pull on the door handle/door knob to make sure all installation steps have been completed correctly and the door has been properly secured.

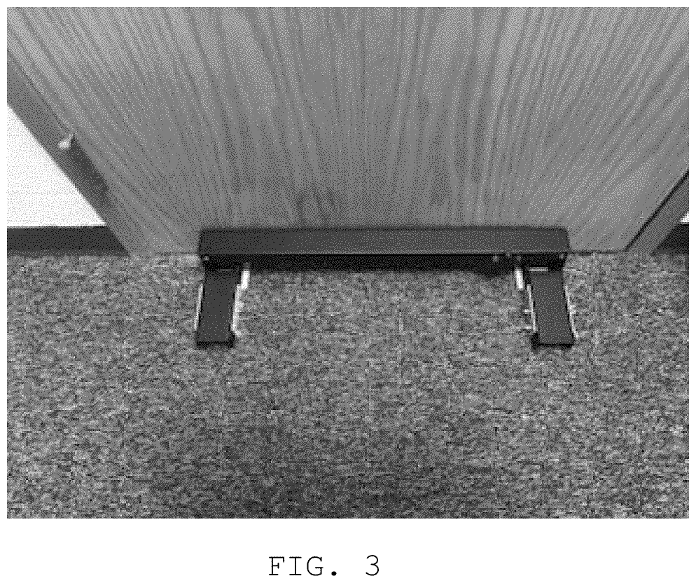

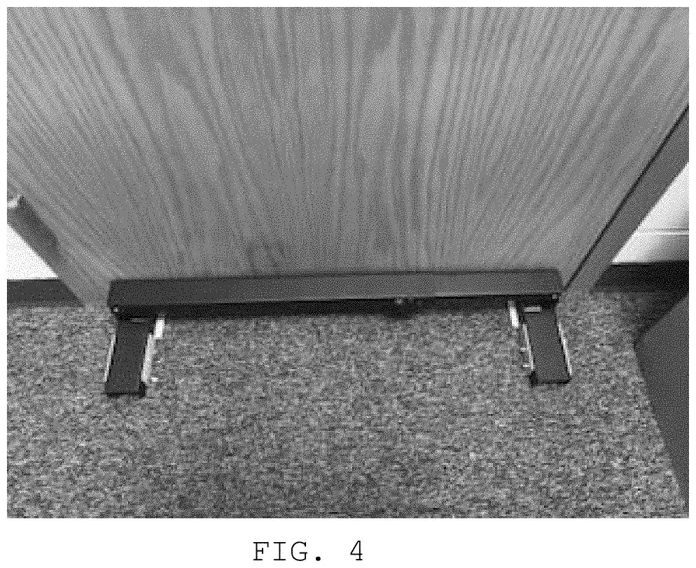

Referring now to FIG. 2, a universal version of the door stopper is shown, which can fit many different door frames. The posts 18 are designed so that different feet 20 can be removably attached, each foot designed for a different frame type. A second embodiment of the door stopper provides a universal door frame fit. FIG. 2 shows the telescoping bar sections, each connected to a door footer, and a pair of universal posts connected to each door footer. The device functions the same as the first embodiment. With the device telescoped to its narrowest width, the device is sat on the floor and slide under the door.

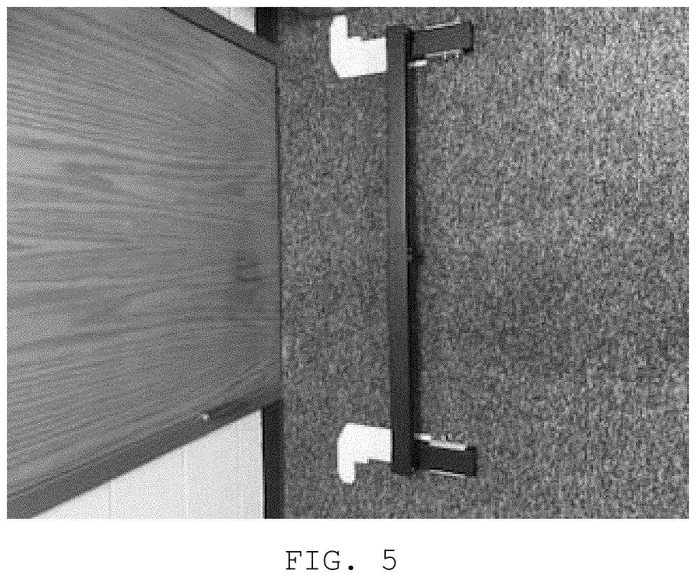

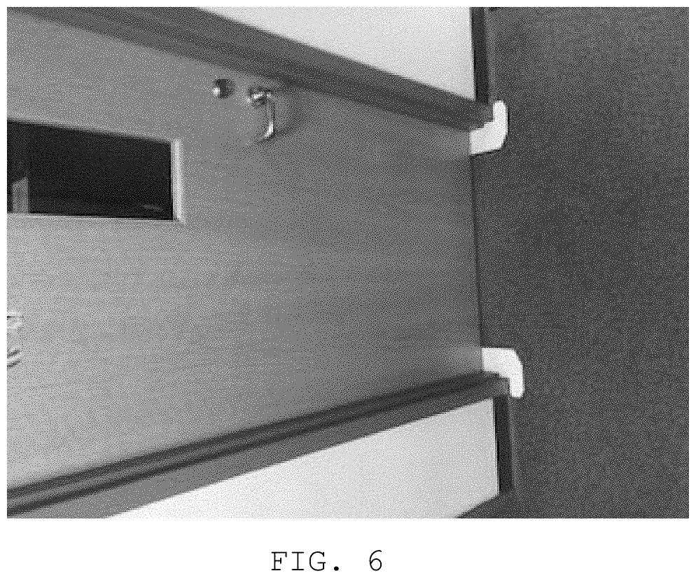

Referring now to FIG. 3, the invention is shown with the feet slide under the door, but before the bar is adjusted so that the fee are slide into contact with the door frame.

Referring now to FIG. 4, the invention is shown with the bar adjusted so that the feet are in contact with the door frame. The telescoping bar is slide as wide as it can go and locked into place with the lock screw.

Referring now to FIG. 5, a top view of the invention is shown before the feet are slide under the door. The door stopper is telescoped as wide as it can go.

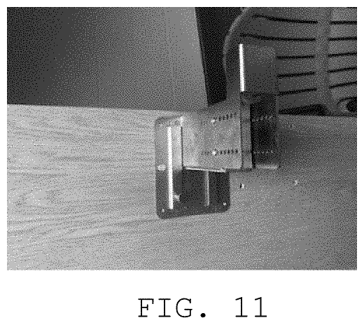

Referring now to FIG. 6, the invention is shown from outside the room, with the feet slide against the frame to prevent the door from opening inwardly. The view from outside the classroom is shown, with the feet engaged to the door frame, to hold the barricade bar tight against the door and to prevent the door from opening inward into the classroom.

Referring now to FIG. 7, a third embodiment of the invention is shown, for outwardly opening doors. This embodiment has a plate which is permanently connected to the door with a pair of rails which are sized to allow the door stop portion to slide into the rails and fit snuggly against the doorframe. When in place this embodiment stops a door from opening outwardly.

Referring now to FIG. 8, a different view of the invention of FIG. 7 is shown.

Referring now to FIG. 9, the plate of FIG. 7 is shown attached to the side of the door inside the room.

Referring now to FIG. 10, the door stopper portion is shown partially slide onto the rails of the plate.

Referring now to FIG. 11, the invention is shown with the door partially open.

Therefore, the foregoing is considered as illustrative only of the principles of the apparatus of a shape memory artificial bait. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A door barricade device comprising:
a plate secured to an outward opening room door on a room side of the door;
the plate having a pair of rails which engage a doorstop device which slides into the rails and abuts the doorframe inside the room, to prevent the door from opening outwardly.

2. The door barricade of claim 1 wherein the room is a classroom.
